(19) United States
(12) Patent Application Publication
(10) Pub. No.: US 2015/0242539 A1
(43) Pub. Date: Aug. 27, 2015

(54) SYSTEM AND METHOD FOR COMPUTING DESIGN PARAMETERS FOR A THERMALLY COMFORTABLE ENVIRONMENT

(71) Applicant: AIRBUS INDIA OPERATIONS PVT. LTD., Bangalore, KA (IN)

(72) Inventors: Punit Tiwari, Bangalore (IN); Arun Rajput, Bangalore (IN); Madhusudhana Reddy, Bangalore (IN)

(21) Appl. No.: 14/421,453

(22) PCT Filed: Aug. 5, 2013
(86) PCT No.: PCT/IN2013/000481

§ 371 Date: Feb. 13, 2015

(30) Foreign Application Priority Data
Aug. 13, 2012 (IN) 3355/CHE/2012

(51) Int. Cl. G06F 17/50; G06F 17/10

(52) U.S. Cl. CPC G06F 17/50; G06F 17/10

(57) ABSTRACT

A system and method for computing design parameters for a thermally comfortable environment is disclosed. In one embodiment, a surface heat transfer coefficient (h_{cal}) is obtained for each body part of one or more thermal manikins in a uniform thermal environment by performing a 1D numerical analysis on the uniform thermal environment based on a given set of boundary conditions for the uniform thermal environment. Further, equivalent temperature (t_{eq}) limits for each body part corresponding to the thermal comfort limits are obtained from known design standards. Furthermore, heat flux limits (q_t limits) are obtained for each body part using associated t_{eq} limits and the h_{cal}. In addition, the design parameters are computed by performing 1D numerical analysis on a non-uniform thermal environment, including one or more thermal manikins, based on a given set of boundary conditions for the non-uniform thermal environment and the obtained q_t limits.

### FIELD OF TECHNOLOGY

The present invention relates generally to numerical analysis, and more particularly relates to numerical analysis to obtain design parameters of any thermal environment.

### BACKGROUND

Typically, a thermal environment inside an enclosure, such as a building, a vehicle or a cockpit of an aircraft, largely depends on parameters such as velocities, temperatures inside the enclosure, solar irradiation incident through a window glass and the like. Designing and sizing of ventilation ducting with a view towards thermal comfort of crew and passengers, typically, requires computer aided design (CAD) data of compartment and ducting and/or computational fluid dynamics (CFD) information. However, such information is, generally, not available in the early stages of design. Further, the CFD study can be very time consuming and expensive.

### SUMMARY

A system and method for computing design parameters for a thermally comfortable environment are disclosed. According to an aspect of the present invention, a method, implemented in a computing device, for computing design parameters for designing a thermally comfortable environment based on occupant's thermal comfort includes obtaining a surface heat transfer coefficient (h_{cal}) for each body part of one or more thermal manikins in a uniform thermal environment by performing a 1D numerical analysis on the uniform thermal environment, including the one or more thermal manikins, based on a given set of boundary conditions for the uniform thermal environment using a 1D numerical analysis tool in the computing device.

Further, the method includes obtaining equivalent temperature (t_{eq}) limits for each body part corresponding to the thermal comfort limits from known design standards. Furthermore, the method includes obtaining heat flux limits (q_t limits) for each body part using associated t_{eq} limits and the h_{cal}.

In addition, the method includes computing the design parameters by performing a 1D numerical analysis on a non-uniform thermal environment, including one or more thermal manikins, based on a given set of boundary conditions for the non-uniform thermal environment and the obtained q_t limits.

According to another aspect of the present invention, an article includes a storage medium having instructions, that when executed by a computing device, result in execution of the method described above.

According to yet another aspect of present invention, a system for computing design parameters for a thermally comfortable environment includes multiple client devices, a computer network, and a remote server coupled to the multiple client devices via the computer network. The remote server includes a processor and memory. The memory includes a 1D numerical analysis tool and a numerical design parameter computation module. One of the client devices accesses the 1D numerical analysis tool via the computer network and obtains the h_{cal} for each body part of the one or more thermal manikins in the uniform thermal environment by performing the 1D numerical analysis on the uniform thermal environment, including the one or more thermal manikins, based on the given set of boundary conditions for the uniform thermal environment using the 1D numerical analysis tool in the computing device.

The one of the client devices, using the 1D numerical analysis tool, further obtains t_{eq} limits for each body part corresponding to the thermal comfort limits from known design standards. Furthermore, the one of the client devices, using the 1D numerical analysis tool, obtains the q_t limits for each body part using associated t_{eq} limits and the h_{cal}. Then, the processor using the numerical design parameter computation module computes the design parameters by performing the 1D numerical analysis on the non-uniform thermal environment, including one or more thermal manikins, based on the given set of boundary conditions for the non-uniform thermal environment and the obtained q_t limits.

The methods, systems and apparatuses disclosed herein may be implemented in any means for achieving various aspects, and other features will be apparent from the accompanying drawings and from the detailed description that follow.

### BRIEF DESCRIPTION OF THE DRAWINGS

Various preferred embodiments are described herein with reference to the drawings, wherein:

FIG. 1 illustrates a process flowchart of an exemplary method of computing design parameters for a thermally comfortable environment;

FIG. 2 illustrates a schematic representation of a comparison of a non-uniform thermal environment with a uniform thermal environment having same total dry heat loss using an equivalent temperature (t_{eq}) approach, according to an embodiment of the invention;

FIG. 3 is a block diagram illustrating a 1D approach used in computing the design parameters for a thermally comfortable environment, using the process described with reference to FIG. 1, according to an embodiment of the invention;

FIG. 4 illustrates a schematic diagram of a 1D model used for h_{cal} extraction for each body part in a uniform thermal environment, such as the one shown in FIG. 2, according to an embodiment of the invention;

FIG. 5 illustrates an exemplary table including h_{cal} data extracted for different body parts in the uniform thermal environment using the 1D model, such as the one shown in FIG. 4;

FIG. 6 illustrates an exemplary table including thermal comfort limits (too cold, neutral and too hot) and associated computed heat flux values;

FIG. 7 illustrates a flow diagram 700 of an exemplary method to compute design parameters using a 1D model in a non-uniform thermal environment, such as the one shown in FIG. 2, according to an embodiment of the invention;

FIG. 8 illustrates an exemplary table including Reynolds number information obtained for data associated with the tables of FIGS. 5 and 6; and

FIG. 9 is a diagrammatic system view of a data processing system in which any of the embodiments disclosed herein may be performed, according to an embodiment of the invention.

The drawings described herein are for illustration purposes only and are not intended to limit the scope of the present disclosure in any way.

### DETAILED DESCRIPTION

A system and method for computing design parameters for a thermally comfortable environment is disclosed. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

The terms “calibration enclosure”, “uniform thermal environment” and “homogeneous environment” are used interchangeably throughout the document. Also, the terms “enclosure”, “non-uniform thermal environment”, “actual environment” and “non-homogeneous environment” are used interchangeably throughout the document. Further, the terms “computer network” and “network” are used interchangeably throughout the document. Furthermore, the terms “total dry heat loss” and “total heat flux” are used interchangeably throughout the document. In addition. The terms “1D model” and “1D thermal network” are used interchangeably throughout the document.

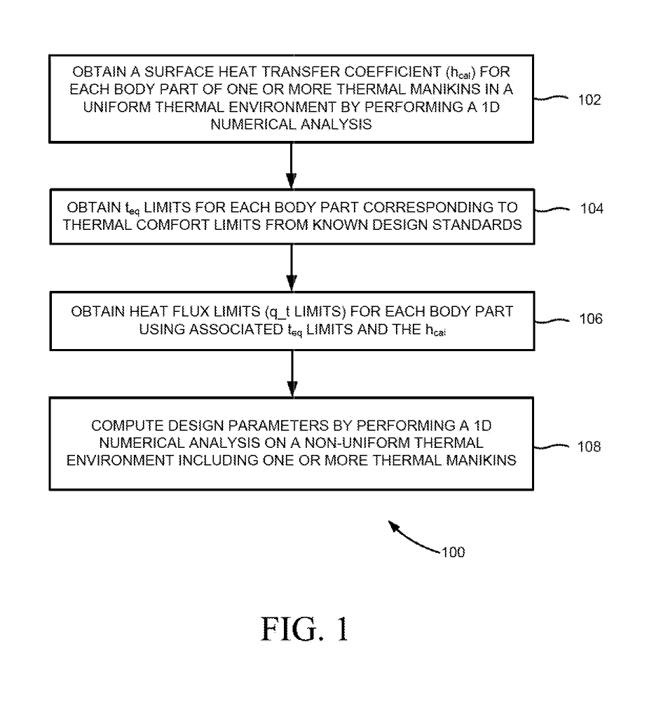

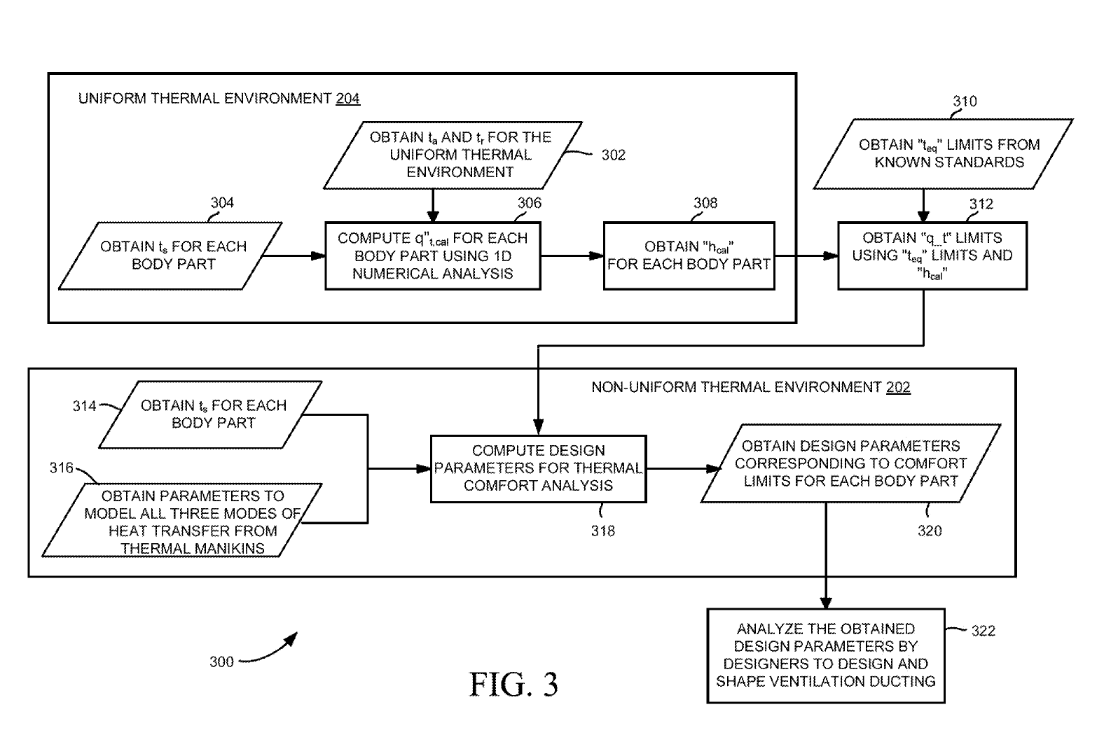

FIG. 1 illustrates a process flowchart 100 of an exemplary method of computing design parameters for a thermally comfortable environment. At block 102, a surface heat transfer coefficient (h_{cal}) is obtained for each body part of one or more thermal manikins in a uniform thermal environment by performing a 1D numerical analysis on the uniform thermal environment, including the one or more thermal manikins, based on a given set of boundary conditions for the uniform thermal environment using a 1D numerical analysis tool in a computing device. For example, 1D refers to numerical analysis performed using equations. This is explained in more detail with reference to FIG. 3.

In one embodiment, a 1D thermal network of the uniform thermal environment, including the one or more thermal manikins, is generated using the 1D numerical analysis tool in the computing device. For example, the one or more thermal manikins include body parts segregated based on a desired thermal comfort resolution. Further, the 1D numerical analysis is performed on the generated 1D thermal network to obtain h_{cal} for each body part using the fluid flow and heat transfer parameters.

At block 104, equivalent temperature (t_{eq}) limits for each body part corresponding to the thermal comfort limits are obtained from known design standards. The t_{eq} limits include too cold t_{eq} limit, cold t_{eq} limit, neutral t_{eq} limit, hot t_{eq} limit and too hot t_{eq} limit. Exemplary known design standards are International standards organization (ISO) design standard and/or company specific design standard. At block 106, heat flux limits (q_limits) are obtained for each body part using associated t_{eq} limits and the h_{cal}.

At block 108, the design parameters are computed by performing the 1D numerical analysis on a non-uniform thermal environment, including one or more thermal manikins, based on a given set of boundary conditions for the non-uniform thermal environment and the obtained q_t limits. Exemplary non-uniform thermal environment includes a building, a vehicle, and an aircraft. In one embodiment, a 1D thermal network of the non-uniform thermal environment, including the one or more thermal manikins, is generated using the 1D numerical analysis tool. The one or more thermal manikins include body parts segregated based on a desired thermal comfort resolution. Further, the 1D numerical analysis is performed on the generated 1D thermal network to obtain q_t for each body part of the one or more thermal manikins based on the given set of boundary conditions for the non-uniform thermal environment using the 1D numerical analysis tool. Exemplary parameters for the given set of boundary conditions of the uniform and non-uniform thermal environments include velocity inlet parameters, thermal manikin body surface parameter, enclosure wall parameters, semi-transparent wall parameters, thermal manikin clothing parameters and outlet parameters. The thermal manikin body surface parameter is a thermal manikin body surface temperature. Exemplary velocity inlet parameters include inlet velocity, inlet flow temperature and nature of flow. Exemplary enclosure wall parameters include a wall temperature and wall surface and material properties. Exemplary semi-transparent wall parameters include semi-transparent wall temperature, radiative properties of wall, and direction and magnitude of solar flux incidence. Exemplary thermal manikin clothing parameters include clothing thickness and cloth thermal conductivity.

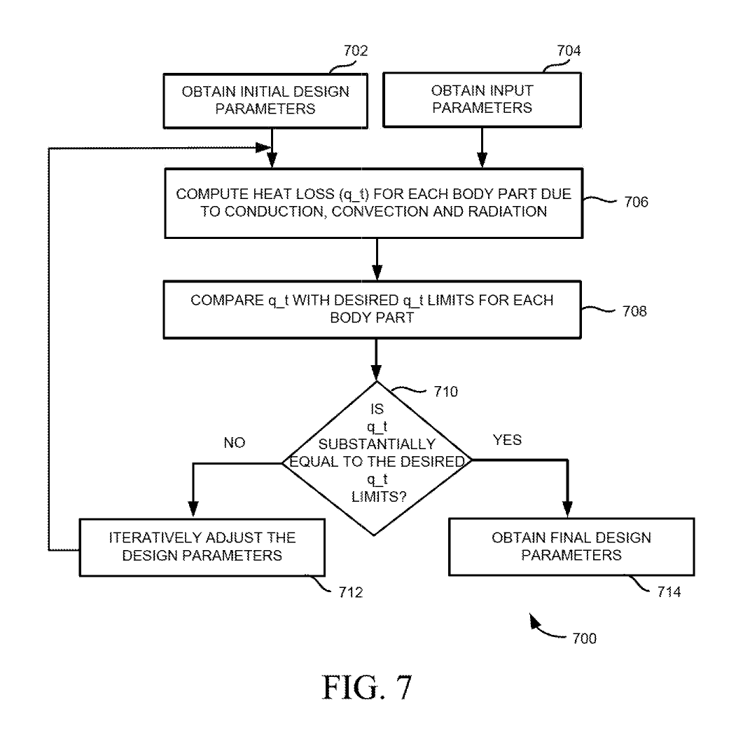

Furthermore in this embodiment, the obtained q_t's are compared with the q_t limits and the design parameters are iteratively adjusted until computed q_t substantially equals to the desired q_t limits. In addition, the design parameters are output upon q_t being substantially equal to the desired q_t limits. This is explained in more detail with reference to FIG. 7. In one embodiment, the design parameters include computing Reynolds numbers associated with each body part of the one or more thermal manikins. The Reynolds numbers are used to compute velocity and temperature distribution in an enclosure and further used in sizing of ducts for regulating the thermal environment of the enclosure.

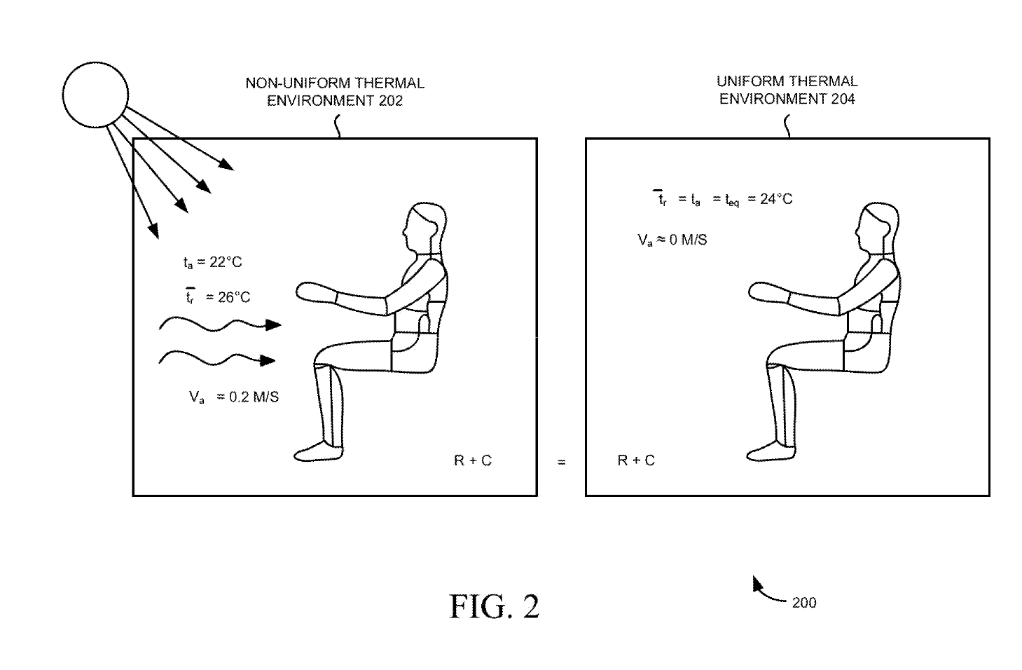

Referring now to FIG. 2, which illustrates a schematic representation 200 of a comparison of a non-uniform thermal environment 202 with a uniform thermal environment 204 having same total dry heat loss using an equivalent temperature (t_{eq}) approach, according to an embodiment of the invention. The non-uniform thermal environment 202 is an actual environment inside an enclosure which is influenced by parameters such as air velocities, temperatures inside the enclosure, and solar irradiation. Whereas, the uniform thermal environment 204 is an environment inside an imaginary enclosure in which air velocity is approximately equal to zero (Va≈0 m/s), temperatures inside the enclosure are constant and which is not exposed to solar irradiation.

In the t_{eq} approach, it is assumed that total dry heat loss (R+C) from an occupant is equal in both the non-homogeneous environment 202 and the homogeneous environment 204. The total dry heat loss is calculated according to the formula:

R+C=hᵣ·(tₛ− t̅ᵣ̅)+h_{c}·(tₛ−tₐ) (1)

where, R is the radiative heat loss, C is the convective heat loss, tₐ is the ambient air temperature (in ° C./K), t̅ᵣ̅ is the mean radiant temperature of the uniform thermal environment 204 and the non-uniform thermal environment 202 (in ° C./K), tₛ is the surface temperature of the occupant (e.g., 34° C. as per Human Thermoregulatory System), h_{c} is the convective heat transfer coefficient (in W/m²° C.), and hᵣ is the radiative heat transfer coefficient (in W/m²° C.).

Further, t_{eq} is defined as a temperature of the uniform thermal environment 204 with the mean radiant temperature ( t̅ᵣ̅ ) equal to the ambient air temperature (ta) and still air in which the occupant has the same heat exchange by convection and radiation as in the non-uniform thermal environment 202. Thus, by definition of t_{eq} the equation for total dry heat loss in the uniform thermal environment 204 can be written as:

R+C=hᵣ·(tₛ−t_{eq})+h_{c}·(tₛ−t_{eq}) (2)

solving for teq, using the above-mentioned equations, yields:

$${t}_{eq} = \frac{{h}_{r} \cdot \overline{{t}_{r}} + {h}_{c} \cdot {t}_{a}}{{h}_{r} + {h}_{c}} = {t}_{s} - \frac{R + C}{{h}_{r} + {h}_{c}} \qquad ( 3 )$$

Based on the above, the present invention provides a method to compute design parameters for a thermally comfortable environment.

Referring now to FIG. 3, which is a block diagram 300 illustrating a 1D approach used in computing design parameters for a thermally comfortable environment, using the process described with reference to FIG. 1, according to an embodiment of the invention. The block diagram 300 illustrates the computations performed in the uniform thermal environment 204 and the non-uniform thermal environment 202.

In the uniform thermal environment 204, at block 302, t̅ᵣ̅ and tₐ for the uniform thermal environment 204 are obtained. At block 304, tₛ for each body part of one or more thermal manikins in the uniform thermal environment 204 are obtained. At block 306, dry heat loss (q″_{t,cal}) for the uniform thermal environment 204 is computed for each body part of the one or more thermal manikins in the uniform thermal environment 204. In one embodiment, q″_{t,cal} is computed using equation:

q″_{t,cal}=q″_{conduction,cal}+q″_{convention,cal}+q″_{radiation,cal} (4)

wherein, q″_{conduction,cal} is the dry heat loss due to conduction, q″ _{convecton,cal} is the dry heat loss due to convection and q″_{radiation, cal} is the dry heat loss due to radiation.

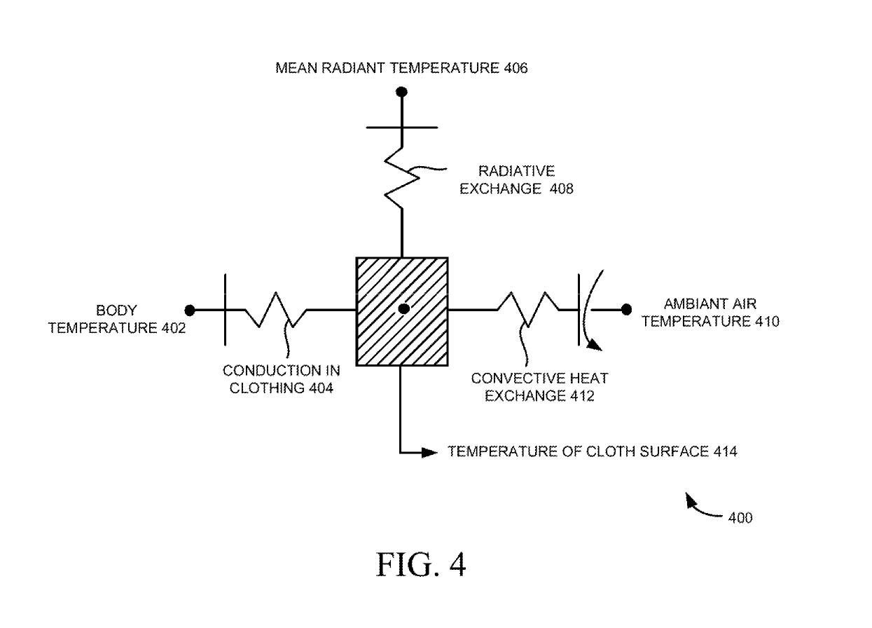

At block 308, h_{cal} is obtained for each body part of the one or more manikins in the uniform thermal environment 204 based on a given set of boundary conditions for the uniform thermal environment 204. In one embodiment, a 1 D thermal network of the uniform thermal environment 204, including the one or more thermal manikins, is generated using the 1D numerical analysis tool in the computing device. The one or more thermal manikins include body parts segregated based on a desired thermal comfort resolution. Further, the 1D numerical analysis is performed on the generated 1D thermal network to obtain h_{cal} for each body part using fluid flow and heat transfer parameters. This is explained in more detail with reference to FIG. 4. For example, h_{cal} is obtained using equation:

$${h}_{cal} = \frac{{q}_{t , cal}^{″}}{{t}_{s} - {t}_{a}} \qquad ( 5 )$$

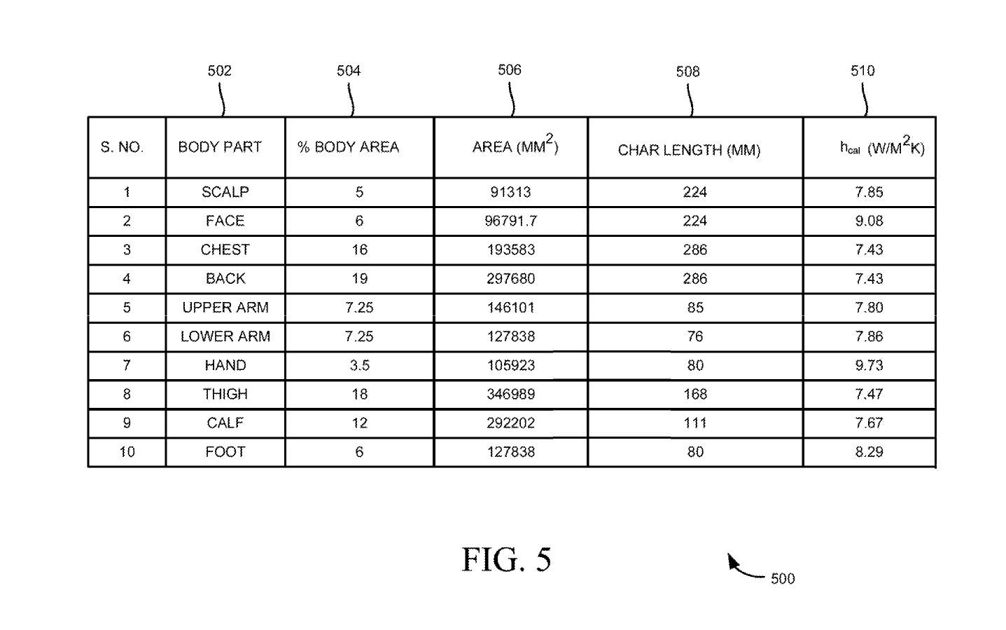

Exemplary h_{cal} data extracted for different body parts in the uniform thermal environment 204 are given in FIG. 5.

At block 310, t_{eq} limits for each body part corresponding to thermal comfort limits are obtained from known standard. The known standards are ISO design standard and/or company design standard. Exemplary t_{eq} limits are too cold t_{eq} limit, cold t_{eq} limit, neutral t_{eq} limit, hot t_{eq} limit and too hot t_{eq} limit. At block 312, heat flux (q_t) limits for each body part are obtained using t_{eq} limits and h_{cal}. In one embodiment, the h_{cal} obtained from the block 308 is used as h_{teq} for the non-uniform thermal environment 202. In this embodiment, t_{eq} can be written as:

$${t}_{eq} = {t}_{s} - \frac{q\_t}{{h}_{teq}} \qquad ( 6 )$$

Solving for q_t, using the equation (6), yields:

q_{—}t==h_{teq}(tₛ−t_{eq}) (7)

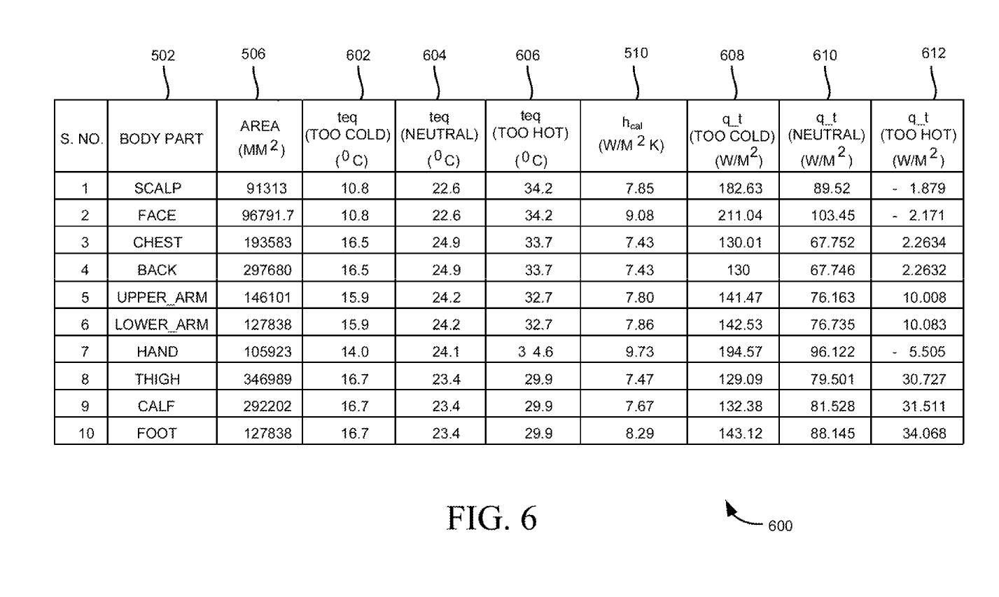

Exemplary q_t limits corresponding to the t_{eq} limits extracted for different body parts in the non-uniform thermal environment 202 are given in FIG. 6.

In the non-uniform thermal environment 202, at block 314, tₛ for each body part of one or more thermal manikins in the non-uniform thermal environment 202 are obtained. At block 316, parameters to model all three modes of heat transfer from the thermal manikins in the non-uniform thermal environment 202 are obtained. At block 318, design parameters are computed by performing a 1D numerical analysis on the non-uniform thermal environment 202 based on a given set of boundary conditions for the non-uniform thermal environment 202.

In one embodiment, a 1D thermal network of the non-uniform thermal environment 202, including the one or more thermal manikins, is generated using the 1D numerical analysis tool. The one or more thermal manikins include body parts segregated based on a desired thermal comfort resolution. Further, the 1D numerical analysis on the generated 1D thermal network is performed to obtain q_{—t} for each body part of the one or more thermal manikins based on the given set of boundary conditions for the non-uniform thermal environment 202 using the 1D numerical analysis tool. This is explained in more detail with reference to FIG. 7. Exemplary parameters for the given set of boundary conditions of the uniform and non-uniform thermal environments include velocity inlet parameters, thermal manikin body surface parameter, enclosure wall parameters, semi-transparent wall parameters, thermal manikin clothing parameters and outlet parameters. The thermal manikin body surface parameter is a thermal manikin body surface temperature. Exemplary velocity inlet parameters include inlet velocity, inlet flow temperature and nature of flow. Exemplary enclosure wall parameters include a wall temperature and wall surface and material properties. Exemplary semi-transparent wall parameters include semi-transparent wall temperature, radiative properties of wall, and direction and magnitude of solar flux incidence. Exemplary thermal manikin clothing parameters include clothing thickness and cloth thermal conductivity.

At block 320, design parameters corresponding to comfort limits are obtained for each comfort zone for each body part. The design parameters are used to compute velocity and temperature distribution in an enclosure. At block 322, the obtained design parameters are analyzed by designers to shape and design ventilation ducting in an enclosure for regulating the thermal environment.

Referring now to FIG. 4, which illustrates a schematic diagram 400 of a 1D model used for h_{cal} extraction for each body part in the uniform thermal environment 204, such as the one shown in FIG. 2, according to an embodiment of the invention. Particularly, FIG. 4 illustrates the dry heat loss from each body part of the one or more manikins in the uniform thermal environment 204 due to conduction, convection and radiation.

As shown, heat loss from body temperature 402 is caused due to conduction in clothing 404. Further, heat loss from mean radiant temperature ( t̅ᵣ̅) 406 is caused due to radiative exchange 408. Furthermore, heat loss from the ambient air temperature (tₐ) 410 is caused due to convective heat exchange 412. In one embodiment, the total dry heat loss (q″_{t,cal}) due to conduction, convection and radiation for the uniform thermal environment 204 is computed using the equation (4). Using the q″_{t,cal} obtained for each body part, h_{cal} is computed using the equation (5). This is explained in more detail with reference to FIG. 3.

Referring now to FIG. 5, which illustrates an exemplary table 500 including h_{cal} data extracted for different body parts in the uniform thermal environment 204 using the 1D model, such as the one shown in FIG. 4. In the table 500, column 502 includes different body parts of the one or more thermal manikins in the uniform thermal environment 204. Further in the table 500, column 504 includes body area corresponding to each body part. Furthermore in the table 500, column 506 includes area (in mm²) corresponding to each body part. In addition in the table 500, column 508 includes characteristic length corresponding to each body part. Also in the table 500, column 510 includes h_{cal} corresponding to each body part. The computation of h_{cal} is described in more detail with reference to FIGS. 3 and 4.

Referring now to FIG. 6, which illustrates an exemplary table 600 including thermal comfort limits (too cold, neutral and too hot) and associated computed heat flux values. In the table 600, the column 502 includes different body parts of the one or more thermal manikins in the uniform thermal environment 204. Further in the table 600, the column 506 includes area (in mm²) corresponding to each body part. Furthermore in the table 600, column 602 includes t_{eq} values corresponding to each body part for feeling too cold. In addition in the table 600, column 604 includes t_{eq} values corresponding to each body part for feeling neutral. Also in the table 600, column 606 includes t_{eq} values corresponding to each body part for feeling too hot.

Further in the table 600, the column 510 includes h_{cal} corresponding to each body part. Furthermore in the table 600, the column 608 includes q_t values corresponding to each body part for feeling too cold. In addition in the table 600, the column 610 includes q_t values corresponding to each body part for feeling neutral. Also in the table 600, the column 612 includes q_t values corresponding to each body part for feeling too hot.

Referring now to FIG. 7, which illustrates a flow diagram 700 of an exemplary method to compute design parameters using a 1D model in a non-uniform thermal environment 202, such as the one shown in FIG. 2, according to an embodiment of the invention. At block 702, initial design parameters are obtained. At block 704, input parameters are obtained. Exemplary input parameters include cloth parameters, convection parameters and radiation parameters. The cloth parameters include cloth conductance, cloth thickness and the like. The convection parameters include Nusselt number correlation for natural, mixed and forced convection, ambient air temperature and the like. The radiation parameters include emissivity of cloth, mean radiant temperature and the like.

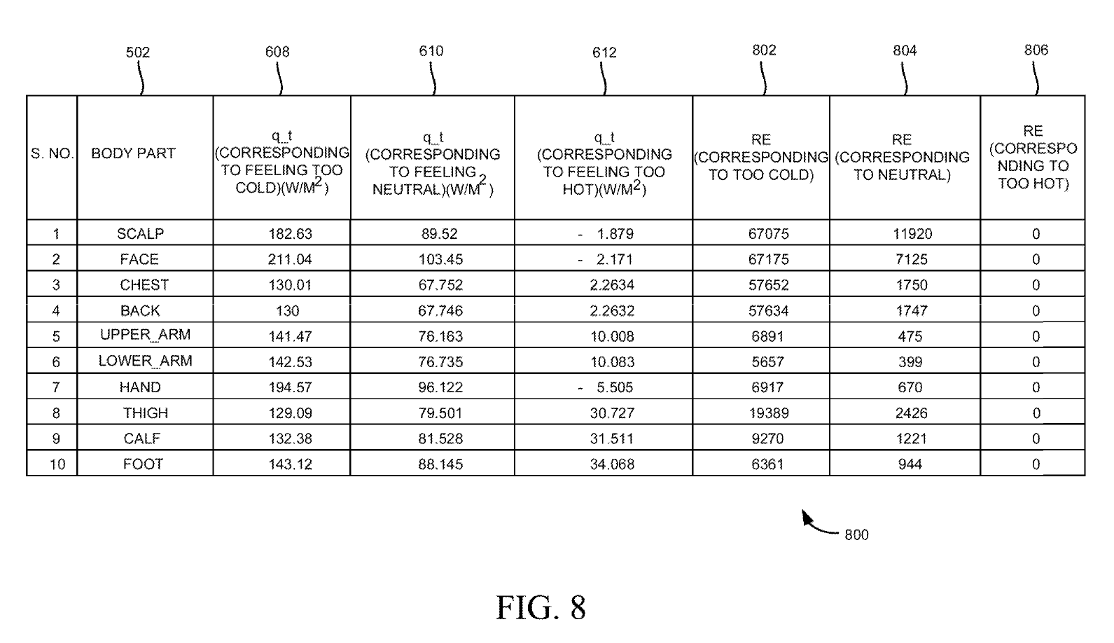

At block 706, q_t is computed for each body part due to conduction, convection and radiation. In one embodiment, q_t is computed, using the equation (7), for each body part of the one or more thermal manikins based on the given set of boundary conditions for the non-uniform thermal environment 202. At block 708, the computed q_t is compared with the desired q_t limits, shown in FIG. 6, for each body part. At block 710, it is determined whether q_t is substantially equal to the desired q_t limits. If it is determined that q_t is not substantially equal to the desired q_t limits then, at block 712, the design parameters are iteratively adjusted and the steps are repeated from block 706. If it is determined that q_t is substantially equal to the desired q_t limits then, at block 714, the final design parameters are obtained. Exemplary final design parameters including Reynolds number data extracted for different body parts is given in FIG. 8.

Referring now to FIG. 8, which illustrates an exemplary table 800 including Reynolds number information obtained for data associated with the tables of FIGS. 5 and 6. In the table 800, the column 502 includes different body parts of the one or more manikins. Further in the table 800, the column 608 includes q_t values corresponding to each body part for feeling too cold. Furthermore in the table 800, the column 610 includes q_t values corresponding to each body part for feeling neutral. In addition in the table 800, the column 612 includes q_t values corresponding to each body part for feeling too hot.

Also in the table 800, the column 802 includes Reynolds number for each body part corresponding to feeling too cold. Further in the table 800, the column 804 includes Reynolds number for each body part corresponding to feeling neutral. Furthermore in the table 800, the column 806 includes Reynolds number for each body part corresponding to feeling too hot.

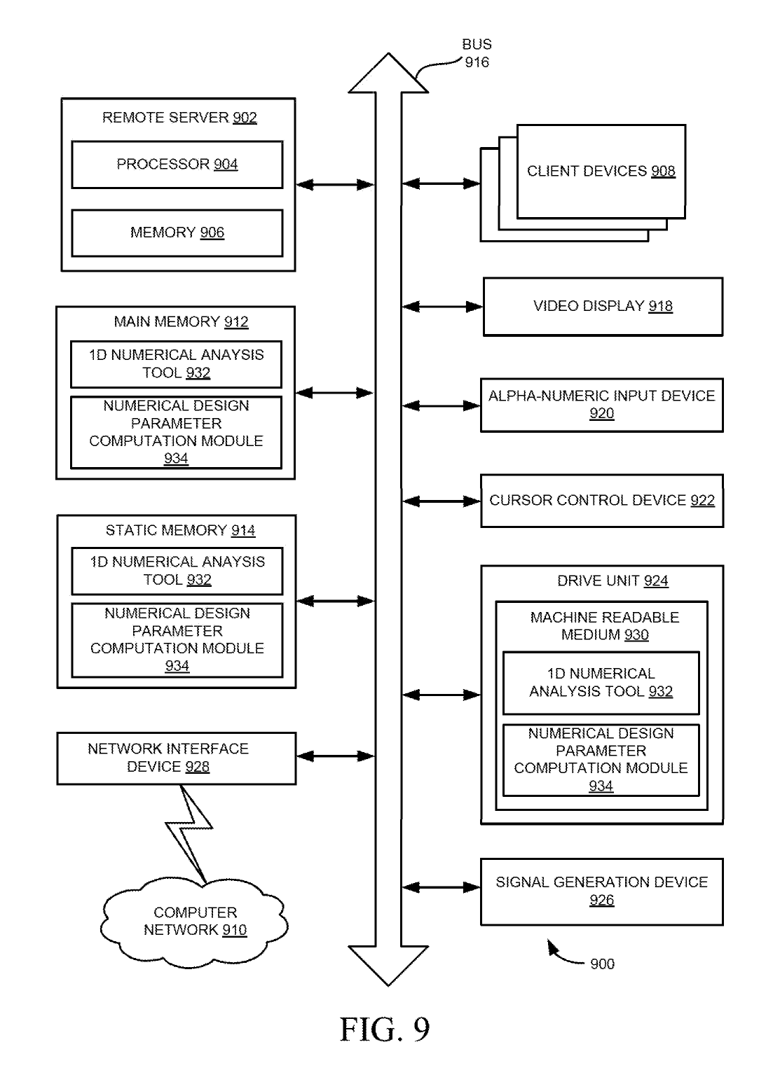

Referring now to FIG. 9, which is a diagrammatic system view 900 of a data processing system in which any of the embodiments disclosed herein may be performed, according to an embodiment of the invention. Particularly, the diagrammatic system view 900 of FIG. 9 illustrates a remote server 902 which includes a processor 904 and memory 906, client devices 908, and a computer network 910. The diagrammatic system view 900 also illustrates main memory 912, static memory 914, a bus 916, a video display 918 an alpha-numeric input device 920, a cursor control device 922, a drive unit 924, a signal generation device 926, a network interface device 928, a machine readable medium 930, a 1D numerical analysis tool 932 (e.g., a mesh generator and finite volume solver), and a numerical design parameter computation module 934.

The diagrammatic system view 900 may indicate a computing device and/or a data processing system in which one or more operations disclosed herein are performed. The remote server 902 may be a server coupled to the client devices 908 via the computer network 910. The remote server 902 may provide access to the 1D numerical analysis tool 932 and the numerical design parameter computation module 934 to the client devices 908 via the computer network 910. The processor 904 may be a microprocessor, a state machine, an application specific integrated circuit, a field programmable gate array, etc.

The memory 906 may be a non volatile memory that is temporarily configured to store a given set of instructions associated with the 1D numerical analysis tool 932 and the numerical design parameter computation module 934. The client devices 908 may be multiple computer devices coupled to the remote server 902 via the computer network 910 for computing design parameters for a thermally comfortable environment. The main memory 912 may be dynamic random access memory and/or primary memory. The static memory 914 may be a hard drive, a flash drive, and/or other memory associated with the data processing system.

The bus 916 may be an interconnection between various circuits and/or structures of the data processing system. The video display 918 may provide graphical representation of information on the data processing system. The alpha-numeric input device 920 may be a keypad, keyboard and/or any other input device of text. The cursor control device 922 may be a pointing device such as a mouse. The drive unit 924 may be a hard drive, a storage system, and/or other longer term storage subsystem.

The signal generation device 926 may be a basic input/output system (BIOS) and/or a functional operating system of the data processing system. The network interface device 928 may perform interface functions (e.g., code conversion, protocol conversion, and/or buffering) required for communications to and from the network 910 between the client devices 908 and the remote server 902. The machine readable medium 930 may provide instructions (e.g., associated with the 1D numerical analysis tool 932 and the numerical design parameter computation module 934) on which any of the methods disclosed herein may be performed. The 1D numerical analysis tool 932 and the numerical design parameter computation module 934 may provide source code and/or data code to the processor 904 to enable any one or more operations disclosed herein.

For example, a storage medium (e.g., the machine readable medium 930) has instructions, that when executed by a computing platform (e.g., the processor 904), result in execution of a method for computing design parameters for a thermally comfortable enclosure having a non-uniform thermal environment 202. The method includes obtaining h_{cal} for each body part of one or more thermal manikins in the uniform thermal environment (e.g., the uniform thermal environment 204 of FIG. 2) by performing the 1D numerical analysis on the uniform thermal environment 204, including the one or more thermal manikins, based on the given set of boundary conditions for the uniform thermal environment 204 using the 1D numerical analysis tool 932. In one example embodiment, the thermal manikin may include body parts segregated based on a desired thermal comfort resolution. Further, the method includes obtaining t_{eq} limits for each body part corresponding to the thermal comfort limits from known design standards.

Furthermore, the method includes obtaining q_t limits for each body part using associated t_{eq} limits and the h_{cal}. Moreover, the method includes computing the design parameters by performing the 1D numerical analysis on the non-uniform thermal environment 202, including the one or more thermal manikins, based on the given set of boundary conditions for the non-uniform thermal environment 202 and the obtained q_t limits.

For performing the 1D numerical analysis on the uniform thermal environment 204 including the one or more thermal manikins, in one embodiment, the storage medium 930 may have instructions to generate the 1D thermal network of the uniform thermal environment 204, including the one or more thermal manikins, using the 1D numerical analysis tool 932. For example, the thermal manikin includes body parts segregated based on a desired thermal comfort resolution. Further, the storage medium 930 may have instructions to perform the 1D numerical analysis on the generated 1D thermal network to obtain h_{cal} for each body part using the fluid flow and heat transfer parameters using the 1D numerical analysis tool 932.

Further, for computing the design parameters by performing the 1D numerical analysis on the non-uniform thermal environment 202, the storage medium 930 may have instructions to generate the 1D thermal network of the non-uniform thermal environment 202, including the one or more thermal manikins, using the 1D numerical analysis tool 932. The thermal manikin includes body parts segregated based on a desired thermal comfort resolution.

The storage medium 930 may also have instructions to perform the 1D numerical analysis on the generated 1D thermal network to obtain q_t for each body part of the one or more thermal manikins based on the given set of boundary conditions for the non-uniform thermal environment 202 using the 1D numerical analysis tool 932. Further, the storage medium 930 may have instructions to compare the obtained q_t's with the q_t limits and iteratively adjust the design parameters until computed q_t substantially equals to desired q_t limits using the processor 904. Furthermore, the storage medium 930 may have instructions to output the design parameters upon q_t being substantially equal to the desired q_t limits on a display device (e.g., the video display 918) using the processor 904.

In accordance with the above described embodiments, one of the client devices 908 accesses the 1D numerical analysis tool 932 via the computer network 910. Further, the one of the client devices 908 obtains h_{cal} for each body part of one or more thermal manikins in the uniform thermal environment 204 by performing a 1D numerical analysis on the uniform thermal environment 204, including the one or more thermal manikins, based on a given set of boundary conditions for the uniform thermal environment 204 using a 1D numerical analysis tool 932. Then, the one of the client devices 908 obtains t_{eq} limits for each body part corresponding to the thermal comfort limits from known design standards. Further, the one of the client devices 908 obtains q_t limits for each body part using associated t_{eq} limits and the h_{cal} using the 1D numerical analysis tool 932.

The processor 904 then computes the design parameters by performing the 1D numerical analysis on the non-uniform thermal environment 202, including one or more thermal manikins, based on a given set of boundary conditions for the non-uniform thermal environment 202 and the obtained q_t limits using the numerical design parameter computation module 934.

In one exemplary implementation, design parameters in a cockpit of an aircraft having a non-uniform thermal environment 202 are computed using the above-described systems and methods. For numerically evaluating design parameters inside the cockpit of the aircraft, the one of the client devices 908 obtains h_{cal} for each body part of one or more thermal manikins in the uniform thermal environment (e.g., the uniform thermal environment 204 of FIG. 2) by performing the 1D numerical analysis on the uniform thermal environment 204, including the one or more thermal manikins, based on a given set of boundary conditions for the uniform thermal environment 204 using a 1D numerical analysis tool 932. Then, the one of the client devices 908 obtains t_{eq} limits for each body part corresponding to the thermal comfort limits from known design standards. Based on the associated t_{eq} limits and the h_{cal} heat flux limits (q_t limits) for each body part is obtained using the 1D numerical analysis tool 932.

Further, the one of the client devices 908 computes the design parameters by performing the 1D numerical analysis on the non-uniform thermal environment 202, including one or more thermal manikins, based on the given set of boundary conditions for the non-uniform thermal environment 202 and the obtained q_t limits using the numerical design parameter computation module 934. In one embodiment, the numerical design parameter computation module 934 generates the 1D thermal network of the enclosure including the one or more thermal manikins in the non-uniform thermal environment 202 using the 1D numerical analysis tool 932. Further, the 1D numerical analysis is performed on the generated thermal network to obtain q_t for each body part of the one or more thermal manikins based on the given set of boundary conditions for the non-uniform thermal environment 202 using the 1D numerical analysis tool 932.

Subsequently, the processor 904 compares the obtained q_t's with the q_t limits and iteratively adjusts the design parameters until computed q_t substantially equals to desired q_t limits using the numerical design parameter computation module 934. Upon q_t being substantially equal to the desired q_t limits the processor 904 outputs the design parameters to a user of the one the client devices 908.

In various embodiments, the methods and systems described in FIGS. 1 through 9 enable designing and sizing of ventilation ducts for a thermally comfortable environment at early design stages of enclosures. The above described method is used when detailed geometry, such as computer aided design (CAD) data of the enclosure is not available and any other detailed analysis, such as computational fluid dynamics (CFD) information cannot be carried out. Further, the above described method is completely performed using 1D numerical analysis to reduce complexity. Furthermore, the above described method helps speed-up design cycle and reduces cost without compromising on the accuracy of determining thermal comfort in enclosures. In addition, the above-described method evaluates thermal comfort by considering other variations along with the occupant's body to account for variations in the flow and thermal conditions on each body part.

Although, the above-mentioned embodiments are described with respect to a 1D numerical analysis tool to generate a thermal network, one can envision doing some parts of the numerical analysis in 2D and 3D as well. In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method, implemented in a computing device, for computing design parameters needed for designing a thermally comfortable environment, based on occupants thermal comfort, comprising:
obtaining a surface heat transfer coefficient (h_{cal}) for each body part of one or more thermal manikins in a uniform thermal environment by performing a 1D numerical analysis on the uniform thermal environment, including the one or more thermal manikins, based on a given set of boundary conditions for the uniform thermal environment using a 1D numerical analysis tool in the computing device;
obtaining equivalent temperature (t_{eq}) limits for each body part corresponding to thermal comfort limits from known design standards;
obtaining heat flux limits (q_t limits) for each body part using associated t_{eq} limits and the h_{cal}: and
computing the design parameters by performing the 1D numerical analysis on a non-uniform thermal environment, including one or more thermal manikins, based on a given set of boundary conditions for the non-uniform thermal environment and the obtained q_t limits.

2. The method of claim 1, wherein performing the 1D numerical analysis on the uniform thermal environment, including the one or more thermal manikins, based on the given set of boundary conditions for the uniform thermal environment comprises:
generating a 1D thermal network of the uniform thermal environment, including the one or more thermal manikins, using the 1D numerical analysis tool in the computing device, wherein the one or more thermal manikins include body parts segregated based on a desired thermal comfort resolution; and
performing the 1D numerical analysis on the generated 1D thermal network to obtain h_{cal} for each body part using fluid flow and heat transfer parameters.

3. The method of claim 1, wherein computing the design parameters by performing the 1D numerical analysis on the non-uniform thermal environment, including the one or more thermal manikins, based on the given set of boundary conditions for the non-uniform thermal environment and the q_t limits comprises:
generating a 1D thermal network of the non-uniform thermal environment, including the one or more thermal manikins, using the 1D numerical analysis tool, wherein the one or more thermal manikins include body parts segregated based on a desired thermal comfort resolution;
performing the 1D numerical analysis on the generated 1D thermal network to obtain q_t for each body part of the one or more thermal manikins based on the given set of boundary conditions for the non-uniform thermal environment using the 1D numerical analysis tool;
comparing the obtained q_t's with the q_t limits and iteratively adjusting the design parameters until computed q_t substantially equals to desired q_t limits; and
outputting the design parameters upon q_t being substantially equal to the desired q_t limits.

4. The method of claim 1, wherein the non-uniform thermal environment is selected from the group consisting of a building, a vehicle, and an aircraft.

5. The method of claim 1, wherein parameters for the given set of boundary conditions of the uniform and non-uniform thermal environments is selected from the group consisting of velocity inlet parameters, thermal manikin body surface parameter, enclosure wall parameters, semi-transparent wall parameters, thermal manikin clothing parameters and outlet parameters.

6. The method of claim 5, wherein the velocity inlet parameters are selected from the group consisting of inlet velocity, inlet flow temperature, and nature of flow.

7. The method of claim 5, wherein the enclosure wall parameters comprise a wall temperature, and wall surface and material properties.

8. The method of claim 5, wherein the semi-transparent wall parameters are selected from the group consisting of semi-transparent wall temperature, radiative properties of wall, and direction and magnitude of solar flux incidence.

9. The method of claim 5, wherein the thermal manikin body surface parameter is a thermal manikin body surface temperature.

10. The method of claim 5, wherein the thermal manikin clothing parameters are selected from the group consisting of clothing thickness and cloth thermal conductivity.

11. The method of claim 1, wherein computing the design parameters comprise computing Reynolds numbers associated with each body part of the one or more thermal manikin, wherein the Reynolds numbers are used to compute velocity and temperature distribution in an enclosure and further used in sizing of ducts for regulating the thermal environment of the enclosure.

12. The method of claim 1, wherein the t_{eq} limits are too cold t_{eq} limit, cold t_{eq} limit, neutral t_{eq} limit, hot t_{eq} limit and too hot t_{eq} limit.

13. The method of claim 1, wherein the known design standards are ISO design standard and/or company specific design standard.

14. A system for computing design parameters for a thermally comfortable environment, comprising:
multiple client devices;
a computer network; and
a remote server coupled to the multiple client devices via the computer network, wherein the remote server comprises:
a processor; and
memory, wherein the memory includes a 1D numerical analysis tool and a numerical design parameter computation module, wherein one of the client devices accesses the 1D numerical analysis tool via the computer network and obtains a surface heat transfer coefficient (h_{cal}) for each body part of one or more thermal manikins in a uniform thermal environment by performing a 1D numerical analysis on the uniform thermal environment, including the one or more thermal manikins, based on a given set of boundary conditions for the uniform thermal environment using a 1D numerical analysis tool in the computing device, wherein the one of the client devices using the 1D numerical analysis tool further obtains equivalent temperature (t_{eq}) limits for each body part corresponding to thermal comfort limits from known design standards, wherein the one of the client devices using the 1D numerical analysis tool furthermore obtains heat flux limits (q_t limits) for each body part using associated t_{eq} limits and the h_{cal}, and wherein the processor using the numerical design parameter computation module computes the design parameters by performing the 1D numerical analysis on a non-uniform thermal environment, including one or more thermal manikins, based on a given set of boundary conditions for the non-uniform thermal environment and the obtained q_t limits.

15. The system of claim 14, wherein performing the 1D numerical analysis on the uniform thermal environment, including the one or more thermal manikins, based on the given set of boundary conditions for the uniform thermal environment comprises:
generating a 1D thermal network of the uniform thermal environment, including the one or more thermal manikins, using the 1D numerical analysis tool in the computing device, wherein the one or more thermal manikins include body parts segregated based on a desired thermal comfort resolution; and
performing the 1D numerical analysis on the generated 1D thermal network to obtain h_{cal} for each body part using fluid flow and heat transfer parameters using the 1D numerical analysis tool.

16. The system of claim 14, wherein computing the design parameters by performing the 1D numerical analysis on the non-uniform thermal environment, including the one or more thermal manikins, based on the given set of boundary conditions for the non-uniform thermal environment and the q_t limits comprises:
generating a 1D thermal network of the non-uniform thermal environment, including the one or more thermal manikins, using the 1D numerical analysis tool, wherein the one or more thermal manikins include body parts segregated based on a desired thermal comfort resolution;
performing the 1D numerical analysis on the generated 1D thermal network to obtain q_t for each body part of the one or more thermal manikins based on the given set of boundary conditions for the non-uniform thermal environment using the 1D numerical analysis tool;
comparing the obtained q_t's with the q_t limits and iteratively adjusting the design parameters until computed q_t substantially equals to desired q_t limits using the numerical design parameter computation module; and
outputting the design parameters upon q_t being substantially equal to the desired q_t limits.

17. The system of claim 14, wherein the non-uniform thermal environment is selected from the group consisting of a building, a vehicle, and an aircraft.

18. The system of claim 14, wherein parameters for the given set of boundary conditions of the uniform and non-uniform thermal environments is selected from the group consisting of velocity inlet parameters, thermal manikin body surface parameter, enclosure wall parameters, semi-transparent wall parameters, thermal manikin clothing parameters and outlet parameters.

19. The system of claim 18, wherein the velocity inlet parameters are selected from the group consisting of inlet velocity, inlet flow temperature, and nature of flow.

20. The system of claim 18, wherein the enclosure wall parameters comprise a wall temperature, and wall surface and material properties.

21. The system of claim 18, wherein the semi-transparent wall parameters are selected from the group consisting of semi-transparent wall temperature, radiative properties of wall, and direction and magnitude of solar flux incidence.

22. The system of claim 18, wherein the thermal manikin body surface parameter is a thermal manikin body surface temperature.

23. The system of claim 18, wherein the thermal manikin clothing parameters are selected from the group consisting of clothing thickness and cloth thermal conductivity.

24. The system of claim 14, wherein computing the design parameters comprise computing Reynolds number associated with each body part of the one or more thermal manikin, wherein the Reynolds numbers is used to compute velocity and temperature distribution in the enclosure and further used in sizing of ducts for regulating the thermal environment of the enclosure.

25. The system of claim 14, wherein the t_{eq} limits are too cold t_{eq} limit, cold t_{eq} limit, neutral t_{eq} limit, hot t_{eq} limit and too hot t_{eq} limit.

26. The system of claim 14, wherein the known design standards are ISO design standard and/or company specific design standard.

27. An article, comprising:
a storage medium having instructions, that when executed by a computing platform, result in execution of a method for computing design parameters needed for designing a thermally comfortable environment, comprising:
obtaining a surface heat transfer coefficient (h_{cal}) for each body part of one or more thermal manikins in a uniform thermal environment by performing a 1D numerical analysis on the uniform thermal environment, including the one or more thermal manikins, based on a given set of boundary conditions for the uniform thermal environment using a 1D numerical analysis tool in the computing device;
obtaining equivalent temperature (t_{eq}) limits for each body part corresponding to thermal comfort limits from known design standards;
obtaining heat flux limits (q_t limits) for each body part using associated t_{eq} limits and the h_{cal}; and
computing the design parameters by performing the 1D numerical analysis on a non-uniform thermal environment, including one or more thermal manikins, based on a given set of boundary conditions for the non-uniform thermal environment and the obtained q_t limits.

28. The article of claim 27, wherein performing the 1D numerical analysis on the uniform thermal environment, including the one or more thermal manikins, based on the given set of boundary conditions for the uniform thermal environment comprises:
generating a 1D thermal network of the uniform thermal environment, including the one or more thermal manikins, using the 1D numerical analysis tool in the computing device, wherein the one or more thermal manikins include body parts segregated based on a desired thermal comfort resolution; and
performing the 1D numerical analysis on the generated 1D thermal network to obtain h_{cal} for each body part using fluid flow and heat transfer parameters.

29. The article of claim 27, wherein computing the design parameters by performing the 1D numerical analysis on the non-uniform thermal environment, including the one or more thermal manikins, based on the given set of boundary conditions for the non-uniform thermal environment and the q_t limits comprises:
generating a 1D thermal network of the non-uniform thermal environment, including the one or more thermal manikins, using the 1 D numerical analysis tool, wherein the one or more thermal manikins include body parts segregated based on a desired thermal comfort resolution;
performing the 1D numerical analysis on the generated 1D thermal network to obtain q_t for each body part of the one or more thermal manikins based on the given set of boundary conditions for the non-uniform thermal environment using the 1D numerical analysis tool;
comparing the obtained q_t's with the q_t limits and iteratively adjusting the design parameters until computed q_t substantially equals to desired q_t limits; and
outputting the design parameters upon q_t being substantially equal to the desired q_t limits.

30. The article of claim 27, wherein the non-uniform thermal environment is selected from the group consisting of a building, a vehicle, and an aircraft.

31. The article of claim 27, wherein parameters for the given set of boundary conditions of the uniform and non-uniform thermal environments is selected from the group consisting of velocity inlet parameters, thermal manikin body surface parameter, enclosure wall parameters, semi-transparent wall parameters, thermal manikin clothing parameters and outlet parameters.

32. The article of claim 27, wherein computing the design parameters comprise computing Reynolds numbers associated with each body part of the one or more thermal manikin, wherein the Reynolds numbers is used to compute velocity and temperature distribution in the enclosure and further used in sizing of ducts for regulating the thermal environment of the enclosure.
